(19) United States
(12) Patent Application Publication
(10) Pub. No.: US 2018/0131838 A1
(43) Pub. Date: May 10, 2018

(54) ORIGINAL READING APPARATUS, IMAGE PROCESSING APPARATUS, CONTROL METHOD FOR IMAGE PROCESSING APPARATUS, AND NON-TRANSITORY COMPUTER-READABLE STORAGE MEDIUM

(71) Applicant: CANON KABUSHIKI KAISHA, Tokyo (JP)

(72) Inventor: Satoru Ishikawa, Ryugasaki-shi (JP)

(21) Appl. No.: 15/794,930

(22) Filed: Oct. 26, 2017

(30) Foreign Application Priority Data
Nov. 10, 2016 (JP) 2016-219396

(51) Int. Cl. H04N 1/387; H04N 1/401; H04N 1/00

(52) U.S. Cl. CPC H04N 1/3878; H04N 1/401; H04N 2201/0081; H04N 1/00745; H04N 1/00816; H04N 1/00718

(57) ABSTRACT

An original reading apparatus, including: an original tray on which an original is placed; a conveyance portion configured to convey the original placed on the original tray; a sensor configured to read an original being conveyed by the conveyance portion; and a processor configured to detect an abnormal pixel from image data output from the sensor, wherein the processor is configured to: determine a length of a shadow in a conveyance direction of the original based on the image data, the shadow occurring at a leading edge area of the original; detect a skew feed amount of the original based on the image data; determine a mask area based on the length of the shadow and the skew feed amount; and detect an abnormal pixel from the image data without use of image data in the mask area having been determined.

### BACKGROUND OF THE INVENTION

### Field of the Invention

The present invention relates to an original reading apparatus configured to read an image of an original, an image processing apparatus, a control method for the image processing apparatus, and a non-transitory computer-readable storage medium.

### Description of the Related Art

Hitherto, with regard to an image reading apparatus configured to read an original image, there has been proposed processing to be executed in a case in which a streak appears on a read image not due to a streak on the original, but due to presence of a foreign matter such as dust. In a flow reading mode of reading an original during conveyance of the original, a streak-like image which appears at a fixed position in a main scanning direction is counted. Then, based on a count value, determination is made on whether or not an abnormal image appears on the read image. In the flow reading mode, a position of a reading sensor is fixed. Therefore, a streak-like abnormal image appears when a foreign matter such as dust fixedly adheres to a surface of a reading platen glass which is located between an original being conveyed and the reading sensor.

According to Japanese Patent Application Laid-Open No. 2003-333290, when a streak-like abnormal image appears in the flow reading mode, an original is temporarily fixed on a surface of a platen glass, and the mode is changed to a fixed reading mode of moving a reading sensor. With this configuration, a streak-like image caused by a foreign matter can be prevented from appearing. When the mode is changed to the fixed reading mode as in Japanese Patent Application Laid-Open No. 2003-333290, more time is required for reading than in the flow reading mode. Therefore, when a large amount of originals are to be read, a long period of time is required to complete reading of all of the originals.

According to Japanese Patent Application Laid-Open No. 2002-185727, it has been proposed that, when a streak-like abnormal image is detected in the flow reading mode, a reading operation in the flow reading mode be prevented from being performed unless a foreign matter causing the abnormal image is removed.

In order to perform detection of streak-like abnormal pixels as in the above-mentioned related art, it is required to find continuity of the abnormal pixels in a sub-scanning direction around a leading edge of an original. In such a case, determination of abnormal pixels in an image near the leading edge of the original cannot be accurately performed due to an influence of a shadow caused by the original. Thus, processing of removing the image near the leading edge of the original from a detection range is essentially required.

For example, as illustrated in FIG. 4A, when an original is skew-fed, a shadow 407 formed near the leading edge of the original obliquely appears. Therefore, a mask area (detection exclusion range) y1-y2 to be excluded from a determination range y0-y3 is extended. Therefore, in the related art, it has been required to set the mask area y1-y2 in accordance with a maximum skew feed amount of an original.

However, when the mask area y1-y2 is set in such a manner, for an original which is not skew-fed as illustrated in FIG. 4B, an image 404 being present in an area farther apart from the leading edge of the original than for the skew-fed original is to be detected. Therefore, there is a high risk of erroneous determination that abnormal pixels 401, 402, and 403 caused by foreign matters adhering to a white reference plate and vertical lines of the image 404 being present on the original continuing over the mask area y1-y2 in the sub-scanning direction.

### SUMMARY OF THE INVENTION

In order to solve the above-mentioned problem, the present invention provides an original reading apparatus configured to reduce erroneous detection of abnormal pixels in an original image having been flow-read and reduce occurrence of erroneous processing caused by the erroneous detection.

According to one embodiment of the invention, there is provided an original reading apparatus, comprising:

an original tray on which an original is placed;

a conveyance portion configured to convey the original placed on the original tray;

a sensor configured to read an original being conveyed by the conveyance portion; and

a processor configured to detect an abnormal pixel from image data output from the sensor,

wherein the processor is configured to:
determine a length of a shadow in a conveyance direction of the original based on the image data, the shadow occurring at a leading edge area of the original;
detect a skew feed amount of the original based on the image data;
determine a mask area based on the length of the shadow and the skew feed amount; and
detect an abnormal pixel from the image data without use of image data in the mask area having been determined.

Further features of the present invention will become apparent from the following description of exemplary embodiments with reference to the attached drawings.

### BRIEF DESCRIPTION OF THE DRAWINGS

FIG. 1 is a sectional view of an image reading apparatus to which an image processing apparatus according to one embodiment of the present invention is mounted.

FIG. 2 is a block diagram of an image processing portion of the image reading apparatus.

FIG. 3 is a flowchart for illustrating processing of the image reading apparatus.

FIG. 4A, FIG. 4B, and FIG. 4C are explanatory views for illustrating operations of skew feed amount detection processing and mask area determination processing.

FIG. 5 is an explanatory view for illustrating operations of the skew feed amount detection processing and the mask area determination processing.

FIG. 6 is an explanatory view for illustrating operations of the skew feed amount detection processing and the mask area determination processing.

FIG. 7 is an explanatory view for illustrating operations of the skew feed amount detection processing and the mask area determination processing.

FIG. 8 is an explanatory view for illustrating operations of the skew feed amount detection processing and the mask area determination processing.

### DESCRIPTION OF THE EMBODIMENTS

Now, a description will be provided of an embodiment of the present invention with reference to the drawings.

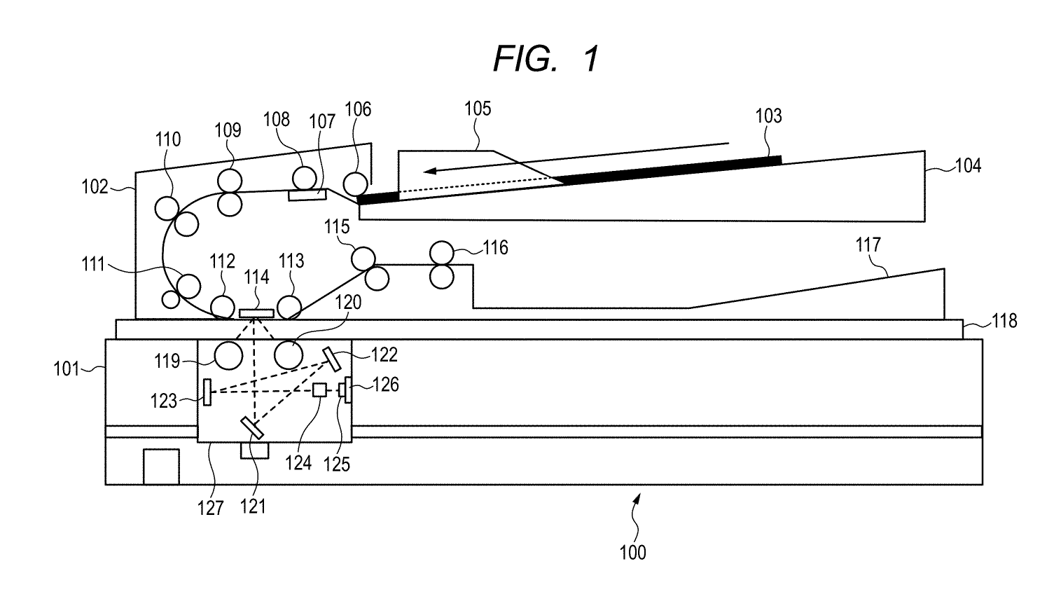

FIG. 1 is a sectional view for illustrating a configuration of an original reading apparatus (hereinafter referred to as an image reading apparatus) 100 to which an image processing apparatus according to one embodiment is mounted. As illustrated in FIG. 1, a main body of an image reading apparatus 100 includes a reading apparatus casing 101 and a sheet conveyance apparatus casing 102. The image reading apparatus 100 is a scanner apparatus which is capable of performing flow reading of an original (an original reading method of reading an original image from an original being moved). In the following, description is made of a configuration and an operation of the image reading apparatus 100.

When the flow reading of an original is to be performed with the image reading apparatus 100, a user sets an original 103 on an original tray 104. At that time, a reading position and a skew feed during conveyance of the original are regulated by an original width guide 105. When the flow reading is started, the image reading apparatus 100 first uses a conveyance roller A 106 to convey the original 103 on the original tray 104. Further, the image reading apparatus 100 uses a friction piece 107 and a conveyance roller B 108 to convey only an uppermost original of a plurality of originals set on the original tray 104, with a friction force generated between the original and the friction piece 107 and friction between originals. After a trailing edge of the uppermost original passes through the conveyance roller B 108, the image reading apparatus 100 successively conveys a next original.

Further, the image reading apparatus 100 uses a conveyance roller C 109, a conveyance roller D 110, a conveyance roller E 111, and a conveyance roller F 112 to convey the original, which has been conveyed from the original tray 104 as described above, so that the original passes through an original reading position at which a white reference plate (reference white plate) 114 is provided. Further, the image reading apparatus 100 uses a delivery roller A 113, a delivery roller B 115, and a delivery roller C 116 to deliver the original to a delivery tray 117.

The white reference plate 114 faces a platen glass 118, and the original passes between the white reference plate 114 and the platen glass 118 during conveyance of the original.

Before the original arrives at the platen glass 118, the white reference plate 114 is read in advance by a line image sensor 125. A reflected light from the white reference plate 114 passes through the platen glass 118, is reflected by a reflection mirror A 121, a reflection mirror B 122, and a reflection mirror C 123, passes through a lens 124, and then is input to the line image sensor 125. At that time, an output from the line image sensor 125 corresponds to an analog voltage for one line, which is obtained by turning on both or any one of a light source A 119 and a light source B 120 and converting a reflected light reflected on the white reference plate 114 into voltage levels. An image processing portion configured to process the output of the line image sensor 125 is provided to a line image sensor circuit board unit 126.

A reading unit 127 receives the light source A 119, the light source B 120, the reflection mirror A 121, the reflection mirror B 122, the reflection mirror C 123, the lens 124, the line image sensor 125, and the line image sensor circuit board unit 126, and has a function of blocking entry of an ambient light from an outside.

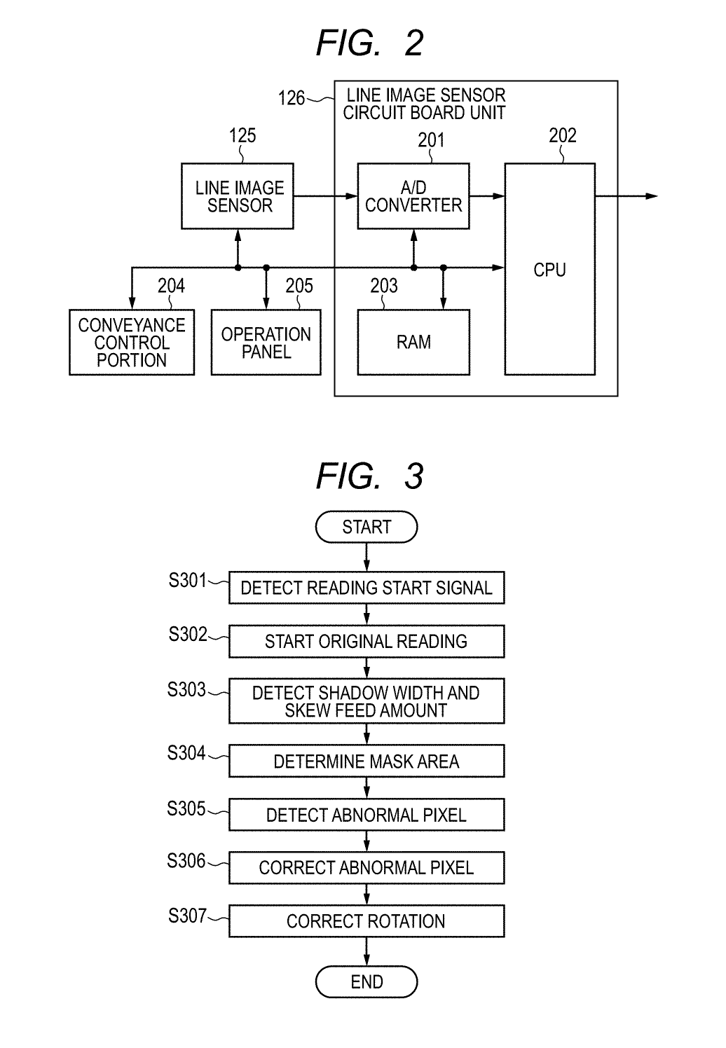

FIG. 2 is a block diagram for illustrating a configuration of the image processing portion of the image reading apparatus 100. The line image sensor 125 reads an image signal (analog) from the conveyed original 103. An A/D converter 201 converts the image signal (analog) read by the line image sensor 125 into digital image data, and transmits the digital image data to a CPU 202.

The CPU 202 loads a program stored in a ROM (not shown) to a RAM 203 and executes the program as needed, to thereby execute various controls. The RAM 203 is used as a storage device for image data, which is to be used when image processing is executed by the CPU 202.

The CPU 202 compares image data, which corresponds to read data of an area in which a shadow is caused by a leading edge of an original, with a predetermined threshold, and stores a comparison result in the RAM 203. A shadow portion is darker than a non-shadow portion. Accordingly, a shadow can be detected based on the comparison result. When the image data has a value which is equal to or larger than the predetermined threshold, CPU 202 stores “0” in the RAM 203. When the image data has a value which is less than the above-mentioned threshold, the CPU 202 stores “1” in the RAM 203. The image data output from the A/D converter 201 indicates a higher tone as the value is larger, and indicates a lower tone (higher in density) as the value is smaller.

An operation panel 205 serves as an interface for a user. A conveyance control portion 204 is configured to control operations of the conveyance roller A 106, the conveyance roller B 108, the conveyance roller C 109, the conveyance roller D 110, the conveyance roller E 111, the conveyance roller F 112, the delivery roller A 113, the delivery roller B 115, and the delivery roller C 116, which are illustrated in FIG. 1.

FIG. 3 is a flowchart for illustrating processing of the image reading apparatus 100. The processing of the flowchart is achieved when the CPU 202 loads a program stored in the ROM (not shown) to the RAM 203 and executes the program as needed.

When the CPU 202 detects a reading start signal from the operation panel 205 in Step S301, the processing proceeds to Step S302. In Step S302, the CPU 202 controls the conveyance control portion 204, the line image sensor 125, and the A/D converter 201 to start reading of an original. Then, the read image data is stored in the RAM 203.

Next, in Step S303, the CPU 202 compares the image data read in Step S302 with the threshold, and stores a comparison result in the RAM 203. Then, the CPU 202 detects a shadow width and a skew feed amount based on the comparison result. Next, in Step S304, based on the shadow width and the skew feed amount detected in Step S303, the CPU 202 determines an abnormal pixel detection mask area (hereinafter referred to as “mask area”) at a leading edge of an original. The CPU 202 functions as a determination unit configured to determine the mask area.

Next, in Step S305, the CPU 202 perform an abnormal pixel detection based on the image data stored in the RAM 203. At this time, the CPU 202 executes a control of not performing an abnormal pixel detection in the mask area determined in Step S304. The CPU 202 functions as a second detection unit configured to detect abnormal pixels in an area other than the mask area of the original image.

That is, the CPU 202 detects the abnormal pixels with use of image data of pixels of the area other than the mask area from the RAM 203.

Next, in Step S306, the CPU 202 corrects the abnormal pixels detected in Step S305. Next, in Step S307, the CPU 202 executes rotation correction based on the skew feed amount detected in Step S303. Then, the processing of the flowchart is ended. The CPU 202 executes the processing illustrated in FIG. 3 for each original.

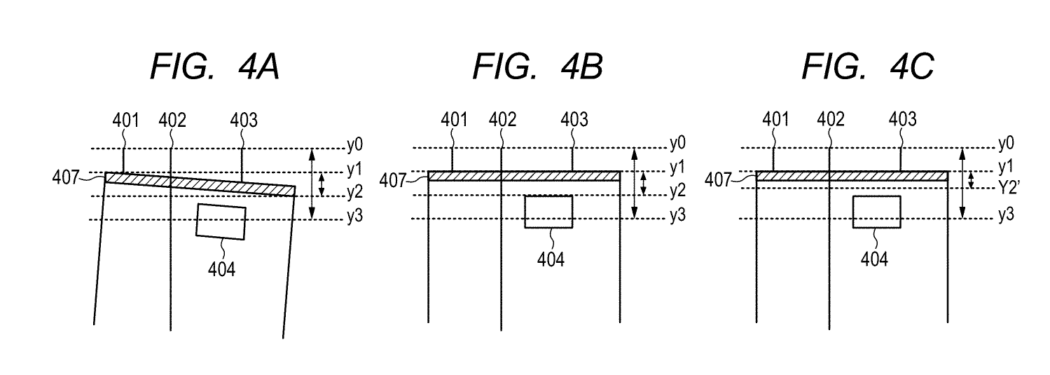

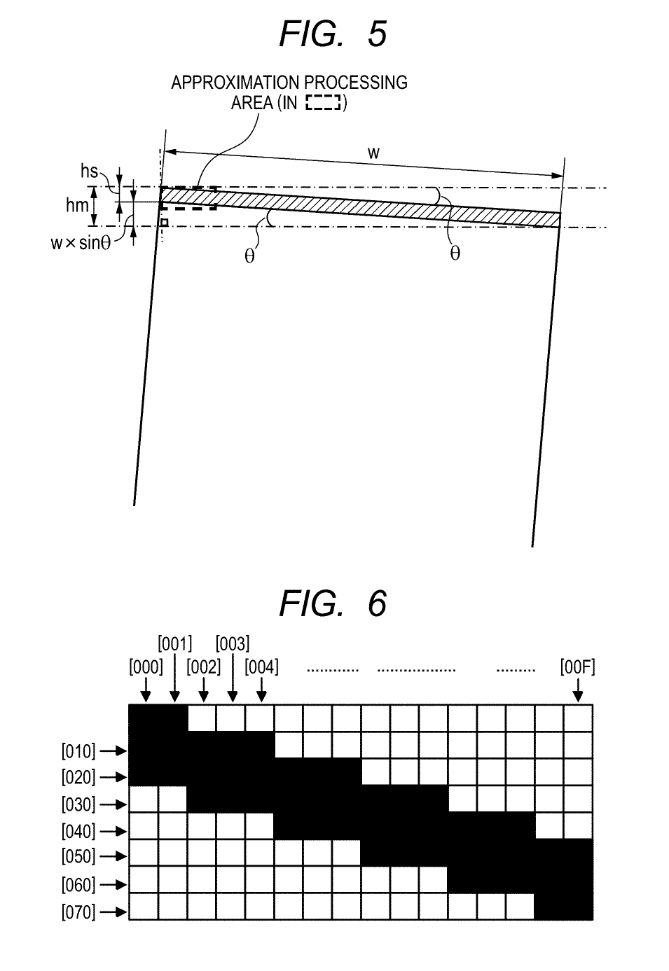

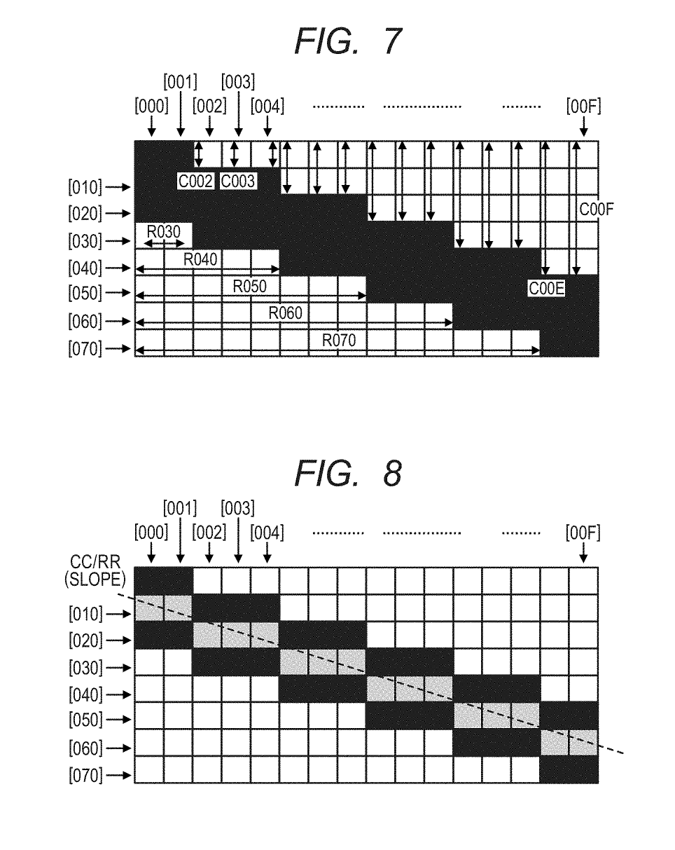

FIG. 4A, FIG. 4B, FIG. 4C, FIG. 5, FIG. 6, FIG. 7, and FIG. 8 are explanatory views for illustrating operations of the skew feed amount detection processing (Step S303) and the mask area determination processing (Step S304) illustrated in FIG. 3. In the embodiment, erroneous detection of abnormal pixels is suppressed by changing the mask area in accordance with a skew feed angle, that is, a skew feed amount of a read original.

As illustrated in FIG. 5, a skew feed angle of an original is represented by “θ”. A length of a shadow in a sub-scanning direction at a leading edge of an original which appears in the case in which the original is not skew-fed is represented by “hs”. A length of the original in a main scanning direction is represented by “w”. In this case, a length “hm” of the mask area in the sub-scanning direction is obtained by the expression “hm=hs+w×sin θ”. In the embodiment, a predetermined length is set for hs in advance. The skew feed angle represents a slope at the leading edge of the original with respect to a direction orthogonal to a conveyance direction of the original. In consideration of an error “α” such as a calculation error, the expression “hm=hs+w×sin θ+a” may be employed. The error “α” is a value which is set in advance.

Now, with reference to FIG. 6 and FIG. 7, detailed description is made of the operations of the skew feed amount detection processing (Step S303) and the mask area determination processing (Step S304) illustrated in FIG. 3, with an approximation processing area of FIG. 5 being enlarged.

In the embodiment, the approximation processing area is set to be a rectangular area defined by 16 pixels arrayed in the main scanning direction and 8 pixels arrayed in the sub-scanning direction. Further, in FIG. 6 to FIG. 8, white pixels each have a comparison result of “0” and indicate that no shadow is present, and black pixels each have a comparison result of “1” and indicate that a shadow is present.

First, a description will be provided of a method of obtaining a shadow width. Each square in the approximation processing area illustrated in FIG. 6 represents a pixel of a comparison result stored in the RAM 203. With regard to items [000] to [00F], the alphanumeric characters in the square brackets hereinafter represent addresses of the RAM 203 in hexadecimal numbers. For example, [00F] represents an address 0x00F.

The addresses [000] to [00F] correspond to addresses of the RAM 203 which represent a width of a first main scanning line in the approximation processing area illustrated in FIG. 5. Addresses of the RAM 203 which represent the next main scanning line (second main scanning line) in the sub-scanning direction being the conveyance direction of the original correspond to the addresses [010] to [01F]. In the case of the example illustrated in FIG. 6, an address of the RAM 203 with a maximum numerical number in the approximation processing area subjected to processing corresponds to the item [07F].

The CPU 202 reads comparison results in the RAM 203 for the approximation processing area subjected to processing, specifies a leading edge of a shadow, and obtains a slope of the image by approximation.

The CPU 202 reads values from the RAM 203 for each main scanning position in accordance with the order of sub-scanning positions, and performs determination. For example, for the main scanning position of 0, the CPU 202 reads values from the RAM 203 in the order of the address [000], the address [010], the address [020], and the address [030], and performs determination. At that time, the CPU 202 determines that an address at which the value is first changed from “0” to “1” corresponds to a shadow starting edge. Further, the CPU 202 determines that a range of from a position determined as the shadow starting edge to a position at which the value is changed from “1” to “0” (shadow ending edge) corresponds to a shadow of the edge of the original which is caused by the light source 119 or the light source 120. Herein, the shadow ending edge corresponds to the leading edge of the original.

In FIG. 6, the solid black area corresponds to a shadow area. That is, the addresses [000], [010], and [020] each correspond to a shadow continuing in the sub-scanning direction. Similarly, for example, the addresses [001], [011], and [021], the addresses [012], [022], and [032], . . . , and the addresses [05F], [06F], and [07F] each also correspond to a shadow.

The CPU 202 counts the number of pixels corresponding to the above-mentioned shadow width in the above-mentioned sub-scanning direction and averages the number of pixels so that the above-mentioned shadow width “hs” in the sub-scanning direction can be obtained. In the example illustrated in FIG. 6, each of the shadow widths in the sub-scanning direction at the plurality of main scanning positions corresponds to 3 pixels. Therefore, hs=3 is given. That is, the CPU 202 counts the number of predetermined pixels continuing in a moving direction of the original (sub-scanning direction) in the area corresponding to the leading edge of the original in the original image having been flow-read, and obtains shadow widths at the edge of the original based on the number of pixels having been counted.

Next, a description will be provided of a method of obtaining the skew feed amount. Similarly to FIG. 6, FIG. 7 is an illustration of the approximation processing area of FIG. 5. As a method of the skew feed amount detection processing (Step S303), first, the CPU 202 calculates a skew feed amount of an original based on comparison results of the approximation processing area subjected to processing.

In the example of FIG. 7, the items C002 and C003 are each a white pixel data piece including 1 pixel continuing in the sub-scanning direction from the leading edge of the read image stored in the RAM 203. That is, the shadow is formed from the second pixel in the sub-scanning direction. Similarly, the items C00E and C00F are each a white pixel data piece including 5 pixels continuing in the sub-scanning direction. An item C000 (not shown) corresponding to the address [000] and an item C001 (not shown) corresponding to the address [001] are each a white pixel data piece including 0 pixels. In order to calculate the skew feed amount, the CPU 202 obtains an average of the number of pixels in each of white pixel data pieces C000 to C00F through use of the following Expression 1.

\sqrt{1/nΣₖ₌₀ⁿ⁻¹(C0ik)²} Expression 1

In the example of FIG. 7, “n” of Expression 1 is 16, and “i” of Expression 1 is a line number in the sub-scanning direction. In this case, when the approximation processing area is divided into 16 pixels arrayed in the main scanning direction, an average number CC of pixels in the sub-scanning direction is given as in Expression 2.

CC=\sqrt{1/nΣₖ₌₀ⁿ⁻¹(C0ik)²}≈2.96 Expression 2

When the number “n” of pixels in the main scanning direction is set as large as possible, the influence of an abnormal image such as a streak continuing in the sub-scanning direction, which may be caused by a foreign matter adhering to the platen glass 118, can be reduced. That is, when the number of pixels in the approximation processing area in the main scanning direction is set larger, the influence of the abnormal pixels can be reduced.

Next, a description will be provided of white pixel data pieces in the main scanning direction. The item R030 is a white pixel data piece including 2 pixels. Similarly, there are given, as white pixel data pieces, R040 including 5 pixels, R050 including 8 pixels, R060 including 11 pixels, and R070 including 14 pixels. An item R000 (not shown) corresponding to the address [000], an item R010 (not shown) corresponding to the address [010], and an item R020 (not shown) corresponding to the address [020] are each a white pixel data piece including 0 pixels. The CPU 202 obtains an average of the number of pixels in each of white pixel data pieces R000 to R070 through use of the following Expression 3.

\sqrt{1/iΣⱼ₌₀ⁱ⁻¹(R0jn)²} Expression 3

In the example of FIG. 7, “i” of Expression 3 is 8, and represents a pixel position in the main scanning direction. In this case, when the approximation processing area is divided into 8 pixels arrayed in the sub-scanning direction, an average number RR of pixels in the main scanning direction is given as in Expression 4.

RR=\sqrt{1/iΣⱼ₌₀ⁱ⁻¹(R0jn)²}≈7.16 Expression 4

Further, the CPU 202 approximates a slope (CC/RR) of the image in the approximation processing area as illustrated in FIG. 8 as in Expression 5.

CC/RR≈2.96/7.16 Expression 5

When a reading width of the original is set to 716 pixels, the “w×sin θ” of FIG. 5 is given as in Expression 6.

$$w \times sin θ = \frac{716}{RR} \times CC = \frac{716}{7.16} \times 2.96 = 296 \qquad Expression 6$$

The CPU 202 adds, to the calculation result of Expression 6, the above-mentioned line width “hs=3” of the shadow in the sub-scanning direction of FIG. 6, and calculates the length hm of the mask area in the sub-scanning direction, thereby determining the mask area (Step S303 of FIG. 3).

As described above, the CPU 202 does not detect abnormal pixels in the mask area from the leading edge of the original. For example, when dust fixedly adheres to the platen glass 118 at the original reading position under the white reference plate 114, an image has streak-like abnormal pixels. However, the CPU 202 does not detect the abnormal pixels in the above-mentioned mask area.

FIG. 4A and FIG. 4B are views for illustrating a maximum mask amount in a mask area y1-y2, which is set in consideration of a maximum skew feed amount of an original, in the related art. Meanwhile, FIG. 4C is a view for illustrating a mask area y1-y2′ derived from a skew feed amount of an original in the embodiment. As illustrated in FIG. 4C, the mask area y1-y2′ in the embodiment is smaller in range than the mask area y1-y2 in the related art illustrated in FIG. 4A and FIG. 4B.

As described above, through update of a mask amount in accordance with a slope obtained by skew feed detection for each page, the mask amount of the image area from a leading edge of an image can be suppressed as much as possible. Further, when a slope amount of a leading edge of an image and a mask amount are calculated for each page based on pixel data in the RAM 203 at the time of reading an image, and maximum values are obtained, the slope amount of a leading edge of an image and a mask amount of a subsequent page may be updated to the maximum value, thereby being capable of dealing with sudden slope of an image.

As described above, through setting of the mask area in accordance with the skew feed amount of an original, determination of a shadow of an original as abnormal pixels can be suppressed, and the mask area can be set smaller than those of the related arts, thereby being capable of improving accuracy in determination of abnormal pixels.

In the above-mentioned embodiment, description is made of the image reading apparatus 100 being capable of reading an original image from an original being moved, as an example. However, the present invention is applicable to any image processing apparatus configured to process an original image read from an original being moved. For example, the present invention may be applied to an information processing apparatus such as a personal computer (PC), which is connected to a scanner like the image reading apparatus 100 and is configured to receive and process an original image having been flow-read by the scanner. In this case, the processing of Step S303 to Step 307 illustrated in FIG. 3 is executed by the PC which receives an original image from the scanner.

Further, in the embodiment, for example, abnormal pixels detected based on detection results of abnormal pixels are corrected. However, processing other than correction may be performed as long as the processing is based on detection results of abnormal pixels. For example, in the case of the image reading apparatus 100, when abnormal pixels are detected, processing of suspending reading of an original and displaying notification such as a message for prompting a user to remove dust or processing of changing a reading mode for an original from the flow reading mode to the fixed reading mode may be performed.

As described above, according to the embodiment of the present invention, the mask area for the abnormal pixel detection near a leading edge of an original during original flow reading is changed in accordance with a skew feed amount, thereby being capable of suppressing erroneous detection of a straight line in the original as abnormal pixels. As a result, for example, occurrence of image degradation due to erroneous processing such as erroneous correction caused by erroneous detection of abnormal pixels can be suppressed.

The above-mentioned configurations and contents of various pieces of data are not limited to those described above, and various configurations and contents may be employed in accordance with usage and purpose. In the above, one embodiment of the present invention is described. However, the present invention may be practiced in various modes such as a system, an apparatus, a method, a program, or a recording medium. Specifically, the present invention may be applied to a system including a plurality of devices, or may be applied to an apparatus including a single device. Further, combinations of the above-mentioned embodiments are all included in the present invention.

According to the embodiment, erroneous detection of abnormal pixels in an original image having been flow-read can be suppressed.

### OTHER EMBODIMENTS

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-219396, filed Nov. 10, 2016, which is hereby incorporated by reference herein in its entirety.

What is claimed is:

1. An original reading apparatus, comprising:
an original tray on which an original is placed;
a conveyance portion configured to convey the original placed on the original tray;
a sensor configured to read an original being conveyed by the conveyance portion; and
a processor configured to detect an abnormal pixel from image data output from the sensor,
wherein the processor is configured to:
determine a length of a shadow in a conveyance direction of the original based on the image data, the shadow occurring at a leading edge area of the original;
detect a skew feed amount of the original based on the image data;
determine a mask area based on the length of the shadow and the skew feed amount; and
detect an abnormal pixel from the image data without use of image data in the mask area having been determined.

2. An original reading apparatus according to claim 1, wherein the processor determines the length of the shadow based on image data in an approximation processing area and determines a skew feed amount of the original, and
wherein the approximation processing area is an area of M×N pixels.

3. An original reading apparatus according to claim 1, wherein the processor executes rotation processing on the image data based on the skew feed amount.

4. An original reading apparatus according to claim 1, wherein the skew feed amount is a value corresponding to a slope of a leading edge of the original with respect to a direction orthogonal to the conveyance direction.

5. An original reading apparatus according to claim 1, wherein the processor determines the length of the shadow, the skew feed amount of the original, and the mask area for each original.

6. An image processing apparatus configured to process an original image read from an original being moved, the image processing apparatus comprising:
a first detection unit configured to detect a skew feed amount of the original from the original image;
a determination unit configured to determine a mask area from the original image; and
a second detection unit configured to detect an abnormal pixel in an area other than the mask area of the original image,
wherein the determination unit determines the mask area for each original based on the skew feed amount detected for each original by the first detection unit.

7. An image processing apparatus according to claim 6, wherein the determination unit determines the mask area to be narrower as the skew feed amount is smaller, and determines the mask area to be wider as the skew feed amount is larger.

8. An image processing apparatus according to claim 6, wherein the determination unit determines the mask area based on the skew feed amount and a number of pixels of predetermined pixels continuing in a moving direction of the original in an area corresponding to a leading edge portion of the original in the original image.

9. An image processing apparatus according to claim 6, wherein the second detection unit detects predetermined pixels continuing in a moving direction of the original in the original image as abnormal pixels.

10. An image processing apparatus according to claim 6, further comprising a processing unit configured to execute processing based on a detection result of the second detection unit.

11. An image processing apparatus according to claim 10, wherein the processing unit corrects abnormal pixels detected by the second detection unit.

12. An image processing apparatus according to claim 6, wherein the image processing apparatus is included in an original reading apparatus configured to read an original image of an original being moved.

13. A control method for an image processing apparatus configured to process an original image read from an original being moved, the method comprising:
a first detection step of detecting a skew feed amount of the original from the original image;
a determination step of determining a mask area from the original image; and
a second detection step of detecting an abnormal pixel in an area other than the mask area of the original image,
wherein the determination step comprises a step of determining the mask area for each original based on the skew feed amount detected for each original in the first detection step.

14. A non-transitory computer-readable storage medium which stores a program for causing a computer to carry out a control method for an image processing apparatus configured to process an original image read from an original being moved, the control method comprising:
a first detection step of detecting a skew feed amount of the original from the original image;
a determination step of determining a mask area from the original image; and
a second detection step of detecting an abnormal pixel in an area other than the mask area of the original image,
wherein the determination step comprises a step of determining the mask area for each original based on the skew feed amount detected for each original in the first detection step.
